(19) United States
(12) Patent Application Publication
(10) Pub. No.: US 2013/0019192 A1
(43) Pub. Date: Jan. 17, 2013

(54) PICKUP HAND DETECTION AND ITS APPLICATION FOR MOBILE DEVICES

(71) Applicants: Hiroshi Itoh, Sagamihara-shi (JP); Susumu Shimotono, Hadano-shi (JP)

(72) Inventors: Hiroshi Itoh, Sagamihara-shi (JP); Susumu Shimotono, Hadano-shi (JP)

(73) Assignee: LENOVO (SINGAPORE) PTE. LTD., Singapore (SG)

(21) Appl. No.: 13/182,355

(22) Filed: Jul. 13, 2011

(51) Int. Cl. G06F 3/048; G06F 3/041; G06F 3/03

(52) U.S. Cl. 715/765; 715/778; 345/156; 345/173

(57) ABSTRACT

A method and apparatus is provided for switching from a first screen display to a second screen display for a user to input data. An apparatus may comprise a first screen display for facilitating a thumb of a user to input on a touch screen of the apparatus, a second screen display for facilitating the other thumb of the user to input on the touch screen of the apparatus, and a switching system. The switching system may be configured to switch a screen item position between the first screen display and the second screen display. The switching system may receive orientation information of the apparatus from an orientation sensor, determine which hand of the user holds the apparatus, and may switch operation of the apparatus between the first screen display to the second screen display.

### BACKGROUND OF THE INVENTION

The present invention relates generally to methods and systems for controlling an interface of a computing system and, more specifically, to methods and systems for controlling a graphical user interface of a handheld electronic device.

Electronic devices, including portable electronic devices, have gained widespread use and may provide a variety of functions including, for example, telephonic, electronic messaging and other personal information manager application functions. Portable electronic devices include, for example, several types of mobile stations, such as simple cellular telephones, smart phones, wireless personal digital assistants (PDAs), tablets, and laptop computers with wireless or Bluetooth® capabilities.

Portable electronic devices, such as PDAs or smart telephones, are generally intended for handheld use and ease of portability. A touch screen display for input and output is particularly useful on such handheld devices, as such handheld devices are small. However, these devices have a limited area for rendering content on the touch screen display and for rendering features or icons, for example, for user interaction. The problem may be further exacerbated when users use the handheld electronic device with one hand while touching the screen with the thumb of the hand since thumbs cannot reach screen items far away on the touch screen.

Therefore, it can be seen that there is a need for a method and system of controlling a graphic interface of a hand held device.

### SUMMARY

In one aspect, an apparatus comprises a switching system that is configured to receive orientation information of the apparatus; determine which hand of a user holds the apparatus; and switch operation of the apparatus between a first screen display and a second screen display of the apparatus depending on which hand of the user holds the apparatus.

In another aspect, a method comprises detecting an orientation of an apparatus; determining which hand of a user holds the apparatus; and rearranging a user interface in accordance with which hand of the user holds the apparatus.

In a further aspect, a computer readable medium having computer usable program code embodied therewith, the computer program code comprises computer program code configured to switch operation between a first screen display and a second screen display, wherein the first screen display and the second screen display have a plurality of screen items; and computer program code configured to determine which hand of a user holds an apparatus before switching operation from the first screen display to the second screen display.

These and other features, aspects and advantages of the present invention will become better understood with reference to the following drawings, description and claims.

### BRIEF DESCRIPTION OF THE DRAWINGS

FIG. 1A is a plan view of an exemplary embodiment of a device with a touch screen;

FIG. 1B is a schematic view of an exemplary embodiment of a device with an orientation sensor;

FIG. 2A is a screenshot of a first screen display when a user holds the device with a left hand according to an exemplary embodiment;

FIG. 2B is a screenshot of a second screen display when a user holds the device with a right hand according to an exemplary embodiment; and

FIG. 3 a flow diagram of an exemplary process for user switching between the first screen display and the second screen display.

### DETAILED DESCRIPTION OF EMBODIMENTS

The following detailed description is of the best currently contemplated modes of carrying out exemplary embodiments. The description is not to be taken in a limiting sense, but is made merely for the purpose of illustrating the general principles, since the scope of the embodiments is best defined by the appended claims.

Various inventive features are described below that can each be used independently of one another or in combination with other features.

Broadly, exemplary embodiments provide methods and systems for controlling an interface of a communications device using an orientation sensor that detects which hand of a user is holding the communications device. This allows for different input configurations based upon which hand is holding the device. Exemplary embodiments optimize the user-friendliness of communications devices from a tactile input perspective. Additional input points and options enable complex applications of functions otherwise impractical for handheld devices. In embodiments of the invention, the flexibility of the input approach may be used to support adaptation to user limitation, for instance, for the disabled. A memory on the communications device may store one or more user profiles which include input combinations for specific functions for specific users.

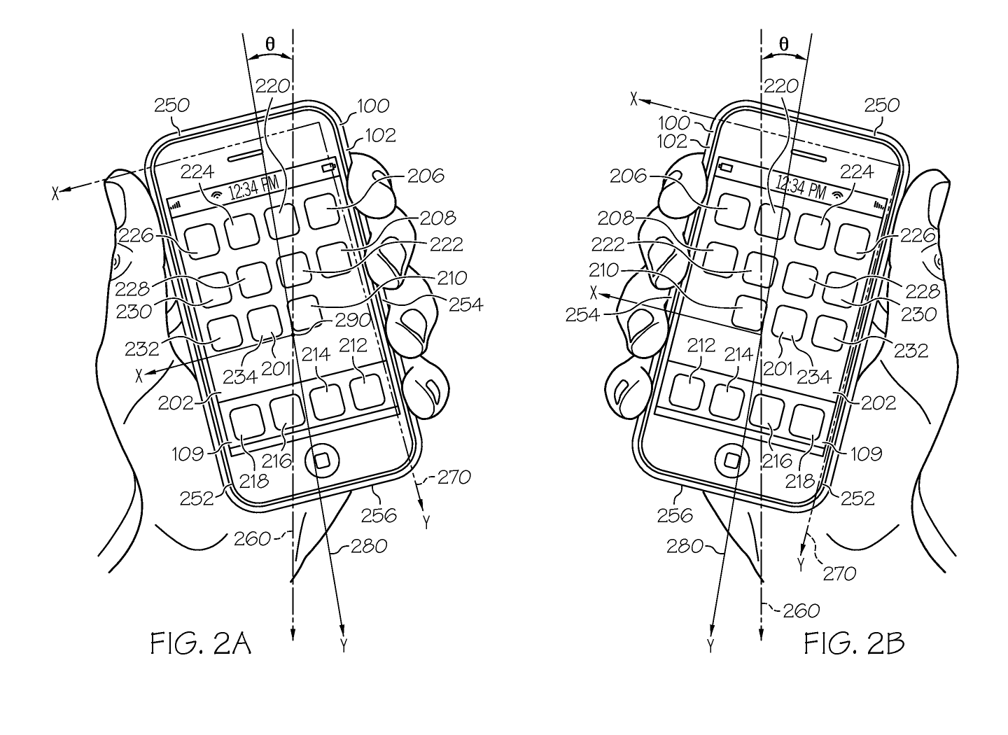

Exemplary embodiments may include an orientation sensor, such as an accelerometer (gravity sensor, or g-sensor), which measures the orientation of the communications device, such as an angle with the gravity vector. Exemplary embodiments may further include a switching system having one or more computer hardware and/or software systems which control switching between a first screen display for the left hand of a user and a second screen display for the right hand of the user. The orientation information may be used by the switching system to determine an arrangement of icons, menus, buttons, sliding bars on a touch screen, or interface controls, for example. More specifically, when the switching system receives the orientation information of the communications device, such as the angle between the communications device and gravity vector. If the angle is positive, as shown in FIG. 2A, the switching system may determine it is the user's left hand holding the communications device. The switching system may switch to a first screen display where most useful icons, communication bars, dialog buttons may be arranged and facilitated within the reach of the left hand thumb. If the angle is negative, as shown in FIG. 2B, the switching system may determine it is the user's right hand holding the communications device. The switching system may switch to a second screen display where most useful icons, communications bars, or dialog buttons may be arranged and facilitated within the reach of the right hand thumb.

Exemplary embodiments may take the form of an entire hardware embodiment, an entire software embodiment (including firmware, resident software, micro-code, etc.) or an embodiment combining software and hardware aspects that may all generally be referred to herein as a “circuit,” “module” or “system.” Furthermore, exemplary embodiments may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction performance system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wired, wire line, optical fiber cable, RF, etc.

Computer program code for carrying out operations of exemplary embodiments may be written in any combination of one or more programming languages, including an object oriented programming language such as Java™ Smalltalk™, C++ or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Exemplary embodiments are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

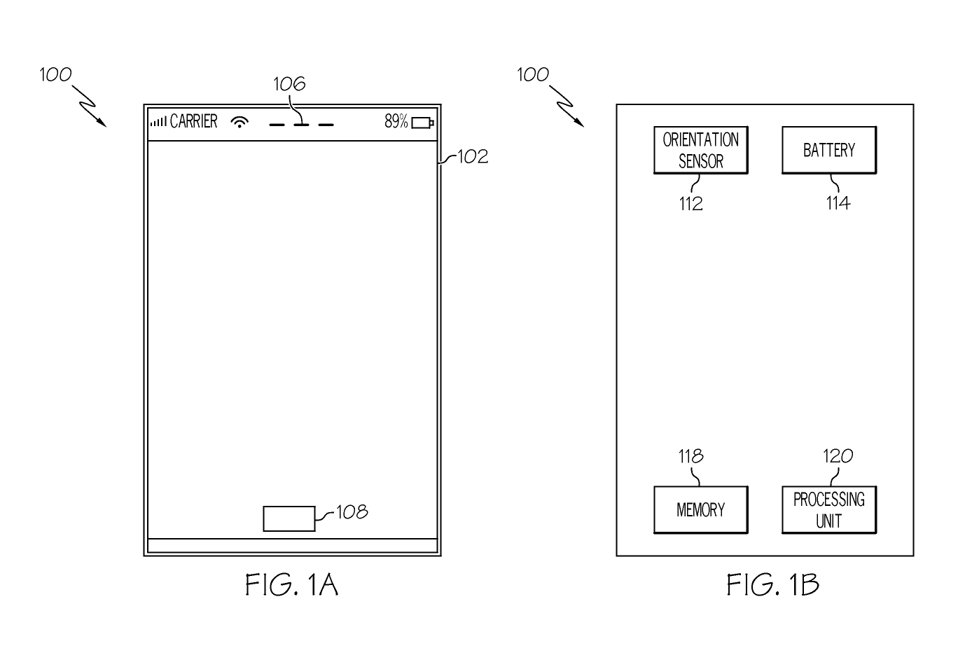

FIG. 1A is an exemplary embodiment of a device 100 with a speaker 106 and a microphone 108. The device 100 may be, for example, a handheld computer, a server, a personal digital assistant, a cellular telephone, a network appliance, a camera, a smart phone, a network base station, a media player, a navigation device, an e-mail device, a game console, a television receiver (e.g., a satellite or cable television set-top box), a digital-video-recorder (DVR), an automatic teller machine (ATM), a security system (e.g., a door or gate access system), or a combination of any two or more of these data processing devices or other data processing devices. In other words, the device 100 may comprise any type of electronic device, general purpose computing device or special purpose computing device that includes a processor, other circuitry, or logic operable to perform the screen switch process described herein to facilitate user's data input by an object, such as a thumb of the user, for example.

In some embodiments, the device 100 may include a display device, such as a touch screen 102, which may be operable to present a first screen display 202 (shown in FIG. 2A) and a second screen display 204 (shown in FIG. 2B). The touch screen 102 may be implemented with liquid crystal display (LCD) technology, light emitting polymer display (LPD) technology, or some other display technology. The touch screen 102 may be sensitive to haptic and/or tactile contact by a user.

In some implementations, the touch screen 102 may comprise a multi-touch-sensitive display. A multi-sensitive display may, for example, process multiple simultaneous touch points, including processing data related to the pressure, degree, and/or position of each touch point.

Referring to FIG. 1B, the device 100 may comprise a battery 114, a memory 118, a processing unit 120 (e.g., a central processing unit (CPU)), and an orientation sensor 112 (e.g., an accelerometer (G-sensor), and a rotational sensor (Gyro)). The orientation sensor 112 may be connected to the processing unit 120 and may be controlled by one or a combination of a monitoring circuit and operating software. The sensor may detect the orientation of the device 100 or information from which the orientation of the device 100 may be determined, such as acceleration.

In some embodiments, the orientation sensor 112 is a two axis accelerometer. In other embodiments, an orientation sensor other than an accelerometer may be used, such as a gravity sensor, a gyroscope, a tilt sensor, an electronic compass or other suitable sensors, or combinations thereof. In some embodiments, the device 100 may comprise two or more sensors, such as an accelerometer and an electronic compass.

As will be appreciated by persons skilled in the art, an accelerometer is a sensor which converts acceleration from motion (e.g., movement of the mobile communication device 100 or a portion thereof due to a strike force) and gravity which are detected by a sensing element into an electrical signal (producing a corresponding change in output) and is available in one, two or three axis configurations. Accelerometers may produce digital or analog output signals depending on the type of accelerometer. Generally, two types of outputs are available depending on whether an analog or digital accelerometer is used: (1) an analog output requiring buffering and analog-to-digital (A/D) conversion; and (2) a digital output which is typically available in an industry standard interface, such as an SPI (Serial Peripheral Interface) or I2C (Inter-Integrated Circuit) interface.

The output of an accelerometer is typically measured in terms of the gravitational acceleration constant at the Earth's surface, denoted g, which is approximately 9.81 m/s² (32.2 ft/s²) as the standard average. The accelerometer may be various types including, but not limited to, a capacitive, piezoelectric, piezoresistive, or gas-based accelerometer. The range of accelerometers vary up to the thousands of g's, however, for portable electronic devices, “low-g” accelerometers may be used. Examples of low-g accelerometers which may be used are micro electro-mechanical systems (MEMS) digital accelerometers from Analog Devices, Inc. (ADI), Freescale Semiconductor, Inc. (Freescale) and STMicroelectronics N.V. of Geneva, Switzerland.

Referring to 2A, in some implementations, the device 100 may have one or more graphical user interfaces 109 on the touch-sensitive display 102 for providing the user access to various system objects and for conveying information to the user.

In some implementations, the first screen display 202 may include a plurality of screen icons 201, e.g., an Evernote® icon 226, a calendar icon 224, a photo icon 220, a camera icon 206, a settings icon 230, a news icon 228, a map icon 222, a weather icon 208, a memo icon 232, a clock icon 234, a TeamViewer® icon 210, a phone icon 218, a mail icon 216, a note icon 214, and a media icon 212. The icons may be arranged in a grid pattern comprising a plurality of columns and rows. Rows and/or columns may be straight, curved, or otherwise. In other exemplary embodiments, icons may be arranged in various other patterns and layouts.

When the device 100 is held by a left hand, the device 100 may be inclined toward the left slightly, since the weight of the device 100 can be supported by the base of the thumb. As shown in FIG. 2A, theta (θ) may be defined as an angle of the y-axis relative to the gravity vector 260 for a two-axis accelerometer in accordance with one exemplary embodiment of the present invention. The measurement axis 280 may be aligned with an axis 270 of the device 100. The x-axis and y-axis are typically aligned with the input plane of the touch screen 102. The z-axis (not shown) is perpendicular to the horizontal plane and detects orientation information when the device 100 is moved vertically. The theta may be calculated using equation (1).

θ=arctan(xₛₑₙₛₒᵣ/yₛₑₙₛₒᵣ) (1)

where xₛₑₙₛₒᵣ and yₛₑₙₛₒᵣ are the measurements from the x axis and y axis of the two-axis accelerometer. It will be appreciated that 0 can also be determined by other means.

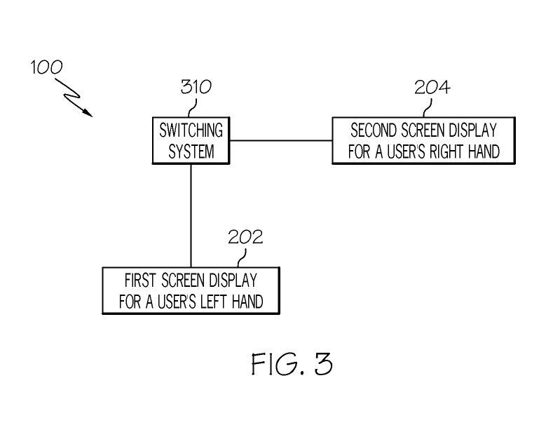

It will be appreciated that the device orientation may be defined by which one of the top 250, bottom 256, left-hand side 252, right-hand side 254 of the device 100 is directed generally upward. The device orientation may be measured by the θ angle, xₛₑₙₛₒᵣ, or yₛₑₙₛₒᵣ. When yₛₑₙₛₒᵣ is positive, a switching system 310 (shown in FIG. 3) may determine that a user holding the device is not lying down and the top 250 of the device 100 is upward. In addition, if the θ angle or xₛₑₙₛₒᵣ (which is also called a slope)) is positive, the switching system 310 may determine it is the user's left hand holding the device 100. The switching system 310 may switch to a first screen display where icons, communication bars, dialog buttons may be arranged and facilitated for the left hand thumb use, as shown in FIG. 2A. When the θ angle or xₛₑₙₛₒᵣ (which is also called a slope) is negative, the switching system 310 may determine it is the user's right hand holding the device 100, the switching system 310 may switch to a second screen display where icons, communications bars, or dialog buttons may be arranged and facilitated for the right hand thumb use, as shown in FIG. 2B.

When yₛₑₙₛₒᵣ is negative, the switching system 310 may determine that a user holding the device is lying down and the top 250 of the device 100 is downward. In addition, if the θ angle or xₛₑₙₛₒᵣ is positive, the switching system 310 may determine it is the user's left hand holding the device 100, the switching system may switch to a first screen display where icons, communication bars, dialog buttons may be arranged and facilitated for the left hand thumb use. When the θ angle or xₛₑₙₛₒᵣ is negative, the switching system 310 may determine it is the user's right hand holding the device 100, the switching system 310 may switch to a second screen display where icons, communication bars, or dialog buttons may be arranged and facilitated for the right hand thumb use.

If xₛₑₙₛₒᵣ and yₛₑₙₛₒᵣ are zero (the device 100 is parallel to the ground), the switching system 310 may determine that the user, who is holding the device close to his/her ear, is lying on his/her side, or the device 100 is placed on a table or chair. The switching system 310 may have memory 118, which stores a screen display at a pre-determined time period, such as a few seconds, for example. When the switching system 310 receives the orientation information in which xₛₑₙₛₒᵣ and yₛₑₙₛₒᵣ are zero from the orientation sensor 112, the switching system 310 may present a previous stored screen display on the touch screen 102.

Referring to FIG. 2B, in one exemplary embodiment, a combination of icons on the first screen display 202 may be the same as and may be shuffled from the icons on the first screen display 202. In another exemplary embodiment, the icons on the first screen display 202 may be different from the icons in the second screen display 204 in FIG. 2B. In still other exemplary embodiments, the icons on the second screen display 204 may include some of the icons found on the first screen display 202. For example, when the first screen display 202 changes to the second screen display 204, the Evernote® icon 226 in FIG. 2A may be switched and moved to the position where the camera icon 206 used to occupy, for example. Similarly, the phone icon 218 may be shuffled and moved to the area where the media icon 212 used to occupy, for example. In this way, the switching system 310 may arrange the most useful icons, menus, buttons, sliding bars, and the like within the reach of the thumb of a user's hand that is holding the device 100.

In an exemplary embodiment, the positions of icons may be rearranged in a symmetrical manner with respect to y-axis when switching between the first and second screen displays. In another exemplary embodiment, when a screen display has relatively few numbers of icons with enough blank space on the display screen, positions of all icons may be shifted, i.e. when a user holds the device with a left hand, icons may be shifted to the left area of the screen display within the reach of the left thumb, and when a user holds the device with a right hand, icons may be shifted to the right area of the screen display within the reach of the right thumb. In further another exemplary embodiment, when a screen display has a user interface image which includes button icons for selecting a function, the positions of the button icons may be shifted according to which hand is holding the device for the ease of each thumb's reach.

Referring to FIG. 3, the device 100 may include a switching system 310, the first screen display 202 shown in FIG. 2A, and the second screen display 204 shown in FIG. 2B. The switching system 310 may have one or more computer software and/or hardware systems which control switching between the first screen display 202 and the second screen display 204. The switching system 310 may switch a screen item between the first screen display and the second screen display. In one embodiment, screen items may include a plurality of icons 201, for example. In another exemplary embodiment, screen items may further include menus, buttons, sliding bars, interface controls, or a plurality of images, such as composite images.

The switching system 310 may receive orientation information, such as an angle of an apparatus with gravity vector, from an orientation sensor. The switching system 310 may determine which hand of a user holds the apparatus, and rearrange a user interface in accordance with which hand of the user holds the apparatus. If the user uses his/her left hand to hold the apparatus, the switching system 310 may present the first screen display 202. If the user uses his/her right hand to hold the apparatus, the switching system 310 may present the second screen display 204.

It should be understood, of course, that the foregoing relate to exemplary embodiments of the invention and that modifications may be made without departing from the spirit and scope of the invention as set forth in the following claims.

We claim:

1. An apparatus, comprising:
a switching system that is configured to:
receive orientation information of the apparatus;
determine which hand of a user holds the apparatus; and
switch operation of the apparatus between a first screen display and a second screen display of the apparatus depending on which hand of the user holds the apparatus.

2. The apparatus of claim 1 further comprising an orientation sensor, wherein the orientation sensor sends out the orientation information of the apparatus.

3. The apparatus of claim 1, wherein the first screen display and the second screen display comprise a plurality of screen items.

4. The apparatus of claim 3, wherein the switching system switches a position of screen items when switching from the first screen display to the second screen display.

5. The apparatus of claim 3, wherein the screen items on the first screen display are displayed in accordance with a contact position of a thumb of the user on a touch screen of the apparatus.

6. The apparatus of claim 3, wherein the screen items in the second screen display are displayed in accordance with a contact position of a thumb of the user.

7. The apparatus of claim 3, wherein screen items are one of an icon and an image.

8. The apparatus of claim 1, wherein the switching system has a memory which stores a screen display.

9. The apparatus of claim 1, wherein the switching system displays the stored screen display.

10. A method, comprising:
detecting an orientation of an apparatus;
determining which hand of a user holds the apparatus; and
rearranging a user interface in accordance with which hand of the user holds the apparatus.

11. The method of claim 10 further comprising presenting a first screen display when the user holds the apparatus with the left hand.

12. The method of claim 10 further comprising presenting a second screen display when the user holds the apparatus with the right hand.

13. The method of claim 12 further comprising shuffling a combination of screen items when switching between the first screen display and the second screen display.

14. The method of claim 10 further comprising arranging screen items according with a contact position of a thumb of the user on a touch screen of the apparatus.

15. A computer readable medium having computer usable program code embodied therewith, the computer program code comprising:
computer program code configured to switch operation between a first screen display and a second screen display, wherein the first screen display and the second screen display have a plurality of screen items; and
computer program code configured to determine which hand of a user holds an apparatus before switching operation between the first screen display and the second screen display.

16. The computer program code of claim 15 further comprising computer program code configured to receive orientation information from an orientation sensor.

17. The computer program code of claim 15 further comprising computer program code configured to display the first screen display in accordance with a contact position of a thumb of the user on a touch screen of the apparatus.

18. The computer program code of claim 15 further comprising computer program code configured to display the second screen display in accordance with a contact position of a thumb of the user on a touch screen of the apparatus.

19. The computer program code of claim 15 further comprising computer program code configured to store a screen display in a memory.

20. The computer program code of claim 15 further comprising computer program code configured to display the stored screen display
